(19) United States
(12) Patent Application Publication
(10) Pub. No.: US 2007/0024651 A1
(43) Pub. Date: Feb. 1, 2007

(54) Ink jet printing

(75) Inventors: Trevor J. Snyder, Newberg, OR (US); David L. Knierim, Wilsonville, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/191,789

(22) Filed: Jul. 27, 2005

(51) Int. Cl. B41J 29/38

(52) U.S. Cl. 347/10

(57) ABSTRACT

A technique of operating an electromechanical drop generator having an electromechanical transducer, including applying across the electromechanical transducer a series of drop firing waveforms in a series of drop firing time intervals to produce a series of drops of substantially identical drop mass, wherein a characteristic of the waveforms is varied from one waveform to a next waveform.

### BACKGROUND

Drop on demand ink jet technology for producing printed media has been employed in commercial products such as printers, plotters, and facsimile machines. Generally, an ink jet image is formed by selective placement on a receiver surface of ink drops emitted by a plurality of drop generators implemented in a printhead or a printhead assembly. For example, the printhead assembly and the receiver surface are caused to move relative to each other, and drop generators are controlled to emit drops at appropriate times, for example by an appropriate controller. The receiver surface can be a transfer surface or a print medium such as paper. In the case of a transfer surface, the image printed thereon is subsequently transferred to an output print medium such as paper.

### BRIEF DESCRIPTION OF DRAWINGS

FIG. 1 is a schematic block diagram of an embodiment of a drop-on-demand drop emitting apparatus.

FIG. 2 is a schematic block diagram of an embodiment of a drop generator that can be employed in the drop emitting apparatus of FIG. 1.

FIG. 3 is a schematic depiction of an embodiment of a timing diagram of a drive signal that can be employed to drive the drop generator of FIG. 2.

FIG. 4 is a schematic illustration of an embodiment of a drop firing waveform that can be applied across an electromechanical transducer of the drop generator of FIG. 2.

FIG. 5 is a schematic illustration of embodiment of another drop firing waveform that can be applied across an electromechanical transducer of the drop generator of FIG. 2.

FIG. 6 is a schematic flow diagram of an embodiment of a procedure for operating the drop generator of FIG. 2.

FIG. 7 is a schematic illustration of a series of ink drop firing waveforms wherein the amplitudes of the waveforms are varied from one waveform to a next waveform.

FIG. 8 is a schematic illustration of a series of ink drop firing waveforms wherein the phases or start delays of the waveforms are varied from one waveform to a next waveform.

FIG. 9 is a schematic flow diagram of an embodiment of another procedure for operating the drop generator of FIG. 2.

### DETAILED DESCRIPTION

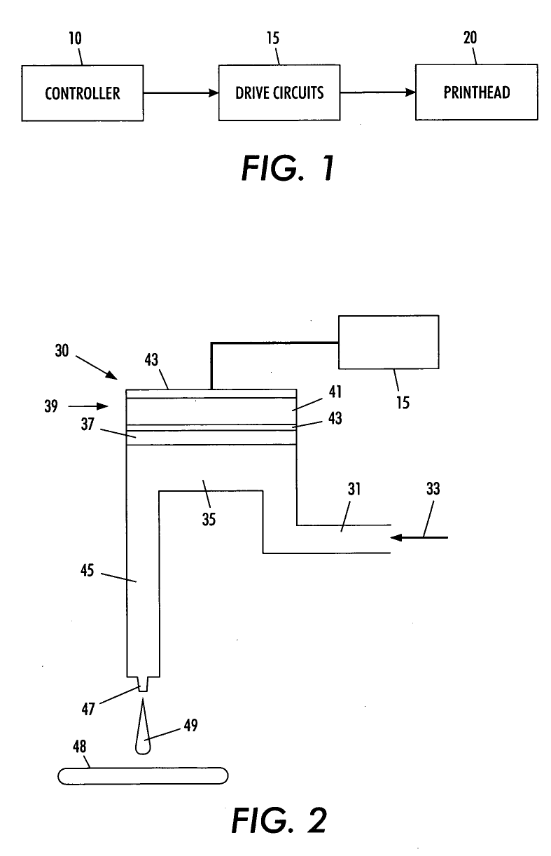

FIG. 1 is a schematic block diagram of an embodiment of a drop-on-demand printing apparatus that includes a controller 10, a plurality of drive circuits 15, and a printhead assembly 20 that can include a plurality of drop emitting drop generators. By way of illustrative example, a drive circuit energizes an associated drop generator pursuant to selection or enablement by the controller 10. Each of the drop generators can employ a piezoelectric transducer. As other examples, each of the drop generators can employ a shear-mode transducer, an annular constrictive transducer, an electrostrictive transducer, an electromagnetic transducer, or a magnetorestrictive transducer. The printhead assembly 20 can be formed of a stack of laminated sheets or plates, such as of stainless steel.

FIG. 2 is a schematic block diagram of an embodiment of a drop generator 30 that can be employed in the printhead assembly 20 of the printing apparatus shown in FIG. 1. The drop generator 30 includes an inlet channel 31 that receives ink 33 from a manifold, reservoir or other ink containing structure. The ink 33 flows into a pressure or pump chamber 35 that is bounded on one side, for example, by a flexible diaphragm 37. An electromechanical transducer 39 is attached to the flexible diaphragm 37 and can overlie the pressure chamber 35, for example. The electromechanical transducer 39 can be a piezoelectric transducer that includes a piezo element 41 disposed for example between electrodes 43 that receive drop firing and optionally non-firing signals from a driver circuit 15 that is selectively enabled by the controller 10. Actuation of the electromechanical transducer 39 causes ink to flow from the pressure chamber 35 to a drop forming outlet channel 45, from which an ink drop 49 is emitted toward a receiver medium 48 that can be a transfer surface, for example. The outlet channel 45 can include a nozzle or orifice 47.

The ink 33 can be melted or phase changed solid ink, and the electromechanical transducer 39 can be a piezoelectric transducer that is operated in a bending mode, for example.

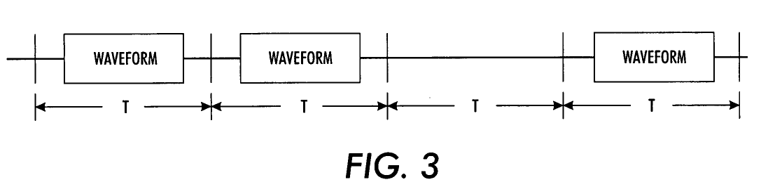

FIG. 3 is a schematic timing diagram of a signal that is applied across a piezeoelectric element of a piezoelectric drop generator by a drive circuit. The drive circuit drives each drop generator, which can be a capacitive load, in such a manner that the output signal across drop generator comprises a series of substantially identical drop firing time intervals T and a plurality of drop firing waveforms, wherein a time interval T can include or not include a drop firing waveform, depending on whether the drop generator is selected to emit a drop. Each drop firing waveform is located in a separate respective drop firing interval T. By way of illustrative example, the firing interval T can be in the range of about 56 microseconds to about 22 microseconds, such that the drop generator can be operated in the range of about 18 KHz to about 45 KHz. As another example, the firing interval T can be in the range of about 1000 microseconds to about 28 microseconds, such that the drop generator can be operated in a range of about 1 KHz to about 36 KHz.

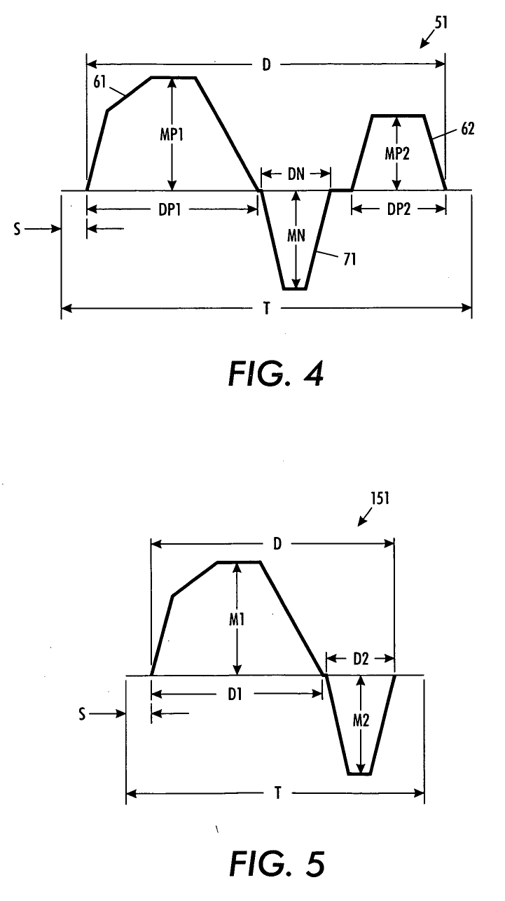

FIG. 4 is a schematic illustration of an embodiment of a drop firing waveform 51 that can be applied across the piezoelectric transducer 39 of the drop generator 20. The waveform comprises a bi-polar voltage signal having in sequence a first positive pulse component 61, a negative pulse component 71, and a second positive pulse 62 component. The pulses are negative or positive relative to a reference such as zero volts. Each pulse is characterized by a pulse duration DP1, DN, DP2 which for convenience is measured between the pulse transition times (i.e., the transition from the reference and the transition to the reference). Each pulse is also characterized by a peak pulse magnitude MP1, MN, and MP2 which herein is a positive number. The drop firing waveform has a duration D, and a start delay S relative to the drop firing interval that contains the drop firing waveform.

FIG. 5 is a schematic diagram of an embodiment of a drop firing waveform 151 that can be produced across a piezoelectric transducer 39. The waveform comprises a bi-polar voltage signal having in sequence a pulse of a first polarity and a pulse of a second polarity, for example a positive going pulse and a negative going pulse. The pulses are negative or positive relative to a reference such as zero volts. The pulses can be separated by a delay. Each pulse is characterized by a pulse duration D1, D2 which for convenience is measured between the pulse transition times (i.e., the transition from the reference and the transition to the reference). Each pulse is also characterized by a peak pulse magnitude M1, M2 which herein is a positive number. The drop firing waveform has a duration D, and a start delay S relative to the drop firing interval that contains the drop firing waveform.

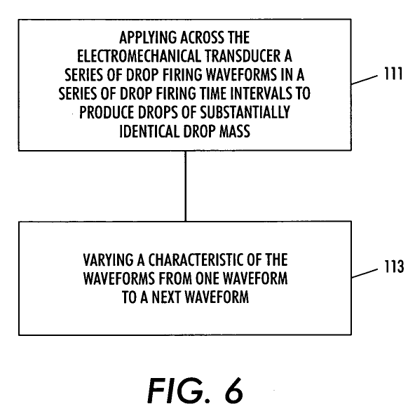

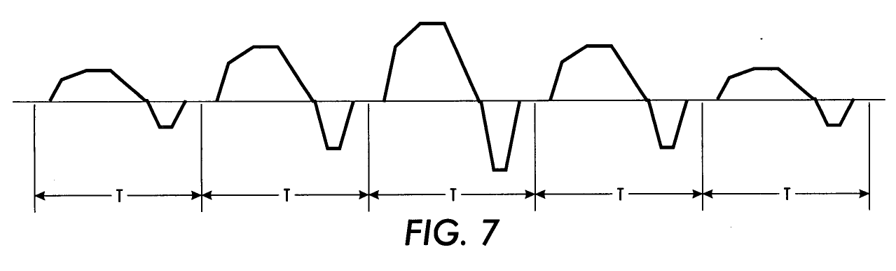

FIG. 6 is an embodiment of a procedure for operating a piezoelectric drop generator. At 111 a series of drop firing waveforms in a series of drop firing time intervals is applied across the electromechanical transducer to produce a series of drops with substantially identical drop mass. At 113 a characteristic of the waveforms is varied from one waveform to a next waveform. By way of illustrative example, the characteristic can be varied in an ordered way such as a sinusoidal or saw-tooth-like manner. Also, the variation can be random.

By way of illustrative example, the durations D of the series of waveforms can be varied, the maximum peak pulse magnitudes can be varied, and/or the durations of a pulse can be varied. Also, the start delays S can be varied. As another example, the amplitudes of the waveforms can be varied, for example wherein the scaling of the waveforms is varied. As yet another example, the shape of the waveforms can be varied. Also, any delays between pulses can be varied from one waveform to a next waveform.

FIG. 7 is a schematic illustration of a series of ink drop firing waveforms wherein the amplitudes of the waveforms are varied from one waveform to a next waveform.

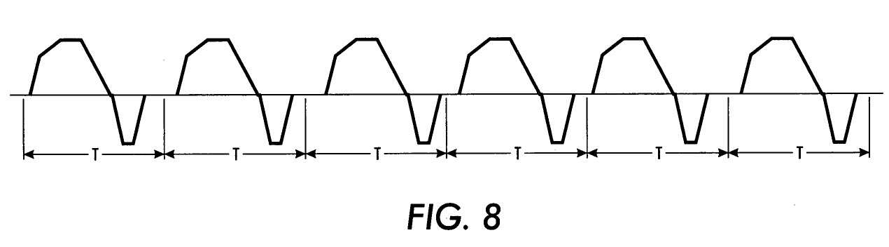

FIG. 8 is a schematic illustration of a series of ink drop firing waveforms wherein the phases or start delays of the waveforms are varied from one waveform to a next waveform.

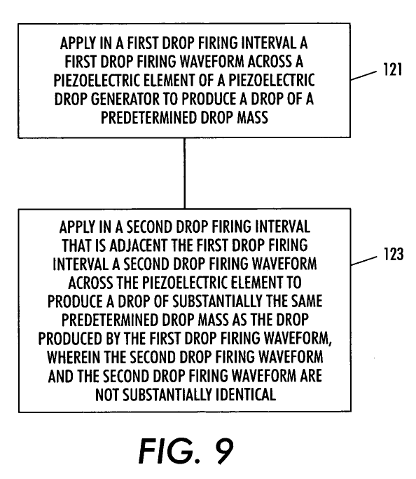

FIG. 9 is a flow diagram of an embodiment of a procedure for operating a piezoelectric drop generator. At 121 a first drop firing waveform in a first drop firing interval is applied across a piezoelectric actuator of the piezoelectric drop generator to produce a drop having a predetermined mass. At 123 a second drop firing waveform in a second drop firing interval adjacent the first drop firing interval is applied across the piezoelectric element to produce a drop having substantially the same predetermined mass as the drop produced by the first drop firing waveform, wherein the second drop firing waveform is not identical to the first drop firing waveform. In this manner, two adjacent or successive non-identical drop firing waveforms are each configured or shaped to produce drops of substantially the same drop mass. For example, a characteristic of the waveforms is varied from one waveform to the next.

By way of illustrative example, as between successive occurrences of drop firing waveforms at a drop generator, the durations D of the waveforms can be different, the maximum peak pulse magnitudes can be different, or pulse durations can be different. Also, the start delays S can be different. As another example, the amplitudes of the waveforms can be different, for example wherein one drop firing waveform can be a non-identical scaled version of the adjacent drop firing waveform. As other examples, one drop firing waveform can be a smaller or larger version of the adjacent drop firing waveform. As yet another example, the shapes of the waveforms can be different. As another example, any delays between pulses can be different.

Generally, at least one characteristic of successive drop firing waveforms can be varied between the successive drop firing waveforms, wherein the successive drop firing waveforms are configured to produce respective substantially identical drops. In this manner, noise such as jitter is introduced into a series of ink drop waveforms in a controlled manner.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method of operating an electromechanical drop generator having an electromechanical transducer, comprising:
applying across the electromechanical transducer a series of drop firing waveforms in a series of drop firing time intervals to produce a series of drops of substantially identical drop mass;
varying a characteristic of the waveforms from one waveform to a next waveform.

2. The method of claim 1 wherein varying a characteristic of the waveforms from one waveform to a next waveform comprises varying an amplitude of the waveforms from one waveform to a next waveform.

3. The method of claim 1 wherein varying a characteristic of the waveforms from one waveform to a next waveform comprises varying a shape of the waveforms from one waveform to a next waveform.

4. The method of claim 1 wherein varying a characteristic of the waveforms from one waveform to a next waveform comprises varying a peak magnitude of the waveforms from one waveform to a next waveform.

5. The method of claim 1 wherein varying a characteristic of the waveforms from one waveform to a next waveform comprises varying a start delay of the waveforms from one waveform to a next waveform.

6. The method of claim 1 wherein varying a characteristic of the waveforms from one waveform to a next waveform comprises varying a duration of the waveforms from one waveform to a next waveform.

7. The method of claim 1 wherein varying a characteristic of the waveforms from one waveform to a next waveform comprises varying a characteristic of the waveforms from one waveform to a next waveform in a sinusoidal manner.

8. The method of claim 1 wherein varying a characteristic of the waveforms from one waveform to a next waveform comprises varying a characteristic of the waveforms from one waveform to a next waveform in a saw-tooth-like manner.

9. A method of operating an electromechanical drop generator having an electromechanical transducer, comprising:
applying across the electromechanical transducer a series of bi-polar drop firing waveforms in a series of drop firing time intervals to produce a series of drops of substantially identical drop mass;
varying a characteristic of the bi-polar waveforms from one bi-polar waveform to a next bi-polar waveform.

10. The method of claim 9 wherein varying a characteristic of the bi-polar waveforms from one bi-polar waveform to a next bi-polar waveform comprises varying an amplitude of the bi-polar waveforms from one bi-polar waveform to a next bi-polar waveform.

11. The method of claim 9 wherein varying a characteristic of the bi-polar waveforms from one bi-polar waveform to a next bi-polar waveform comprises varying a shape of the bi-polar waveforms from one bi-polar waveform to a next bi-polar waveform.

12. The method of claim 9 wherein varying a characteristic of the bi-polar waveforms from one bi-polar waveform to a next bi-polar waveform comprises varying a peak magnitude of the bi-polar waveforms from one bi-polar waveform to a next bi-polar waveform.

13. The method of claim 9 wherein varying a characteristic of the bi-polar waveforms from one bi-polar waveform to a next bi-polar waveform comprises varying a start delay of the bi-polar waveforms from one bi-polar waveform to a next bi-polar waveform.

14. The method of claim 9 wherein varying a characteristic of the bi-polar waveforms from one bi-polar waveform to a next bi-polar waveform comprises varying a duration of the bi-polar waveforms from one bi-polar waveform to a next bi-polar waveform.

15. The method of claim 9 wherein varying a characteristic of the bi-polar waveforms from one bi-polar waveform to a next bi-polar waveform comprises varying a characteristic of the bi-polar waveforms from one bi-polar waveform to a next bi-polar waveform in a sinusoidal manner.

16. The method of claim 9 wherein varying a characteristic of the bi-polar waveforms from one bi-polar waveform to a next bi-polar waveform comprises varying a characteristic of the bi-polar waveforms from one bi-polar waveform to a next bi-polar waveform in a saw-tooth-like manner.

17. A method of operating an electromechanical drop generator having an electromechanical transducer comprising:
applying in a first drop firing interval a first drop firing waveform across the electromechanical transducer to produce a drop having a predetermined mass; and
applying in a second drop firing interval adjacent the first drop firing interval a second drop firing waveform across the electromechanical transducer to produce a drop having the predetermined mass, wherein the second drop firing waveform is not identical to the first drop firing waveform.

18. The method of claim 17 wherein the first drop firing waveform and the second drop firing waveform have different maximum magnitudes.

19. The method of claim 17 wherein the second drop firing waveform is a scaled version of the first drop firing waveform.

20. The method of claim 17 wherein the second drop firing waveform is a smaller version of the first drop firing waveform.

21. The method of claim 17 wherein the second drop firing waveform is a larger version of the first drop firing waveform.

22. The method of claim 17 wherein the first drop firing waveform has a start delay relative to the first drop firing interval, wherein the second drop firing waveform has a start delay relative to the second drop firing interval, and wherein the start delay of the second drop firing waveform is different from the start delay of the first drop firing waveform.
